(19) United States
(12) Patent Application Publication
(10) Pub. No.: US 2016/0176400 A1
(43) Pub. Date: Jun. 23, 2016

(54) LANE KEEPING ASSIST APPARATUS

(71) Applicants: DENSO CORPORATION, Aichi (JP); TOYOTA JIDOSHA KABUSHIKI KAISHA, Aichi (JP)

(72) Inventors: Takahito Nakano, Kariya-shi, Aichi-ken (JP); Taisuke Hasegawa, Kariya-shi, Aichi-ken (JP); Hidenobu Kinugasa, Nagoya (JP)

(21) Appl. No.: 14/907,088

(22) PCT Filed: Jul. 23, 2014
(86) PCT No.: PCT/JP2014/069388

§ 371 Date: Jan. 22, 2016

(30) Foreign Application Priority Data
Jul. 23, 2013 (JP) 2013-152908

(51) Int. Cl. B60W 30/12

(52) U.S. Cl. CPC B60W 30/12; B60W 2510/202

(57) ABSTRACT

In a state where steering required torque is outputted (S1: YES), the steering required torque is canceled (S12) based on the fact that a state of driver torque being inputted has continued (S11: YES). A cancellation delay time, which represents the length of time from when the driver torque is inputted until the steering required torque is canceled, is set to be shorter when the driver torque is higher than or equal to a timer-ON threshold 2 than when the driver torque is between a timer-ON threshold 1 and the timer-ON threshold 2. Consequently, in the case where a steering wheel is quickly turned by a driver and thus high torque is inputted to the steering wheel, control torque will be canceled in a short time and thus steering will be performed in quick response to the steering wheel operation of the driver. As a result, an uncomfortable feeling caused to the driver will be suppressed.

### TECHNICAL FIELD

The present invention relates to lane keeping assist apparatuses that perform steering control for lane keeping.

### BACKGROUND ART

There have been known various lane keeping assist apparatuses that assist a vehicle in keeping a lane during traveling. The lane keeping assist apparatuses cause an actuator to generate a steering torque when the vehicle is likely to depart or has departed from the traveling lane. In addition, the lane keeping control apparatuses are sometimes referred to as lane departure prevention apparatuses or lane departure suppression apparatuses.

Moreover, as a matter of course, there are cases where a driver intentionally changes lane. Therefore, even in a situation where the steering torque is generated by the steering control for lane keeping, the lane keeping control apparatuses cancel the generation of the steering torque when it is likely that the driver has intentionally operated a steering wheel. In addition, hereinafter, the steering torque generated by the steering control for lane keeping will be referred to as control torque.

A condition for canceling the generation of the control torque is, for example, that a state of torque inputted by the driver to the steering wheel (hereinafter, to be referred to as driver torque) being higher than or equal to a given value has continued for a given time.

Moreover, in Patent Document 1, there is disclosed a technique according to which: when the driver torque is inputted in the opposite direction to the control torque, in other words, when the driver torque is inputted in the direction of departing from the lane, the longer the time for which the driver torque is inputted, the more the control torque is weakened. Consequently, when the driver intends to change the lane, it is possible to suppress an uncomfortable feeling which the driver feels due to the generation of the control torque in the opposite direction to the driver torque.

### PRIOR ART LITERATURE

### Patent Literature

[Patent Document 1] Japanese Patent Application Publication No. JP2010036852A

### SUMMARY OF THE INVENTION

### Problems to be Solved by the Invention

However, with the technique of Patent Document 1, in the beginning of the steering wheel operation by the driver, the control torque is hardly suppressed. Therefore, when an obstacle suddenly appears in front of the vehicle and thus the steering wheel is quickly operated by a large amount to avoid it, a relatively-high control torque comes to be generated in the opposite direction to the driver torque.

Moreover, if the control torque was weakened in a short time, it would be possible to relieve the uncomfortable feeling caused to the driver even in the above situation. However, if the control torque was weakened in a short time, the chances of the steering control for lane keeping being canceled in situations where it should not be canceled would be increased.

For example, in a situation where there are a pair of neighboring lanes respectively on the left and right of the own lane (the lane on which the own vehicle is traveling) and one neighboring lane has a large-sized vehicle present on it while the other neighboring lane is vacant, the own vehicle may be traveling on the opposite side of the center of the own lane to the large-sized vehicle. In this situation, since the driver has no intention of making a lane change, the steering control for lane keeping should not be canceled.

Moreover, not limited to the above example, if the generation of the control torque was canceled only upon the input of the driver torque for a short time, the control torque would be canceled even with a slight operation of the steering wheeling. Therefore, the chances that it is impossible to generate the control torque in situations where it should be generated might be increased.

The present invention has been made in view of the above circumstances. Therefore, a primary object of the present invention is to provide a lane keeping assist apparatus which can suppress an uncomfortable feeling caused to a driver while reducing situations where the generation of the control torque is suppressed.

### Means for Solving the Problems

A lane keeping assist apparatus according to the present invention is installed on a vehicle. The lane keeping assist apparatus includes: a control torque outputting unit (12, 12A) that outputs control torque for keeping the vehicle in a traveling lane; and a driver torque detection unit (11) that detects driver torque, the driver torque being torque inputted by a driver of the vehicle to a steering wheel of the vehicle. The lane keeping assist apparatus is characterized in that: in a state of outputting the control torque, the control torque outputting unit stops the output of the control torque based on the detection of the driver torque; and the control torque outputting unit varies, according to the driver torque detected by the driver torque detection unit, a time from when the driver torque is inputted until the output of the control torque is stopped.

The driver torque reflects the driver's intension. Therefore, by varying, according to the driver torque, the time from when the driver torque is inputted until the output of the control torque is stopped, it is possible to conform the time to the driver's intension. Consequently, it is possible to suppress an uncomfortable feeling caused to the driver while reducing situations where the generation of the control torque is suppressed.

### BRIEF DESCRIPTION OF THE DRAWINGS

FIG. 1 is a block diagram illustrating the overall configuration of a lane keeping assist system according to a first embodiment.

FIG. 2 is a flow chart illustrating a cancellation determination process executed by a processing unit of the lane keeping assist system according to the first embodiment.

FIG. 3 is a schematic view illustrating the relationship between driver torque and cancellation delay time.

FIG. 4 is a schematic view illustrating the relationship between vehicle speed, lateral position, road curvature, and the cancellation delay time.

FIG. 5 is a block diagram illustrating the overall configuration of a lane keeping assist system according to a second embodiment.

FIG. 6 is a flow chart illustrating a cancellation determination process executed by a processing unit of the lane keeping assist system according to the second embodiment.

FIG. 7 is a schematic view illustrating integral value lines that represent cancellation torque integral values.

### EMBODIMENTS FOR CARRYING OUT THE INVENTION

### First Embodiment

Hereinafter, the first embodiment of the present invention will be described with reference to the drawings. In addition, in the present embodiment, white lines drawn on a road are referred to as lane boundary lines; the area between a lane boundary line and another lane boundary line is referred to as a lane.

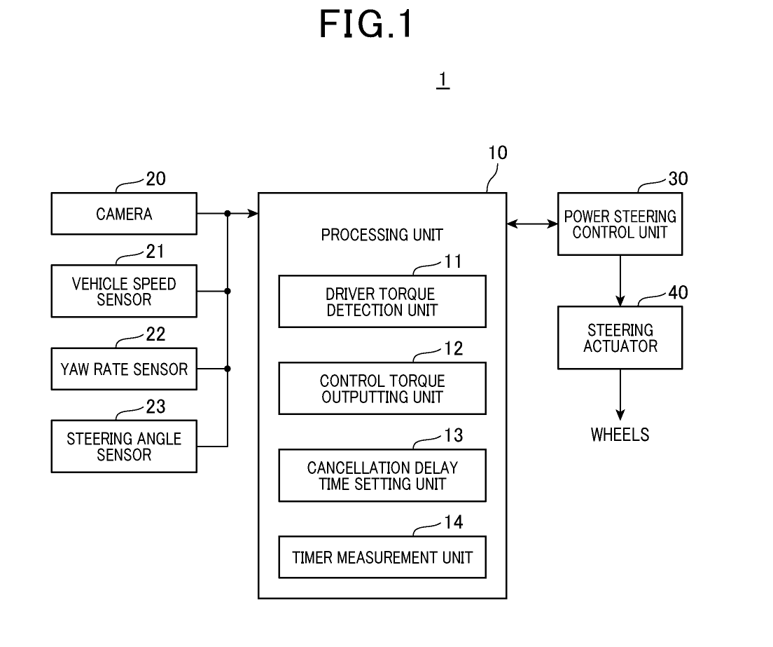

FIG. 1 illustrates the overall configuration of a lane keeping assist system 1 according to the present embodiment. The lane keeping assist system 1 is installed on a vehicle, such as a passenger car, to assist the driving operation of a driver so as to enable the own vehicle (the vehicle on which the lane keeping assist system 1 is installed) to travel keeping a lane demarcated by left and right lane boundary lines.

Specifically, as shown in FIG. 1, the lane keeping assist system 1 includes a processing unit 10 that functions as a lane keeping assist apparatus of the present invention, a camera 20, a vehicle speed sensor 21, a yaw rate sensor 22, a steering angle sensor 23, a power steering control unit 30 and a steering actuator 40.

The processing unit 10 is implemented by a well-known microcomputer which includes a CPU, a ROM and a RAM. Through the execution of programs stored in the ROM by the CPU, the processing unit 10 functions as a driver torque detection unit 11, a control torque outputting unit 12, a cancellation delay time setting unit 13 and a timer measurement unit 14. In performing these functions, the processing unit 10 uses sensing signals respectively outputted from the camera 20, the vehicle speed sensor 21, the yaw rate sensor 22 and the steering angle sensor 23.

The camera 20 captures images of a front road surface in a traveling direction of the own vehicle. The camera 20 calculates, using a well-known lane boundary line recognition technique, a departure angle representing the angle between the lane boundary lines and the traveling direction of the own vehicle, distances from the own vehicle to the lane boundary lines (hereinafter, to be referred to as lateral position), a curve radius (i.e., road curvature) and the like. Then, the camera 20 sends these calculated parameters as captured-image information to the processing unit 10. In addition, in the case of the camera 20 having only a function of obtaining captured-image pictures, the processing unit 10 calculates the captured-image information based on the captured-image pictures provided by the camera 10.

The vehicle speed sensor 21 is implemented by a well-known vehicle speed sensor for sensing the traveling speed of the vehicle. The vehicle speed sensor 21 sends the sensing results of the traveling speed to the processing unit 10. The yaw rate sensor 22 is implemented by a well-known yaw rate sensor for sensing the turning angular velocity in a turning direction of the vehicle. The yaw rate sensor 22 sends the sensing results of the yaw rate to the processing unit 10. The steering angle sensor 23 is implemented by a well-known steering angle sensor for sensing the steering angle of the vehicle. The steering angle sensor 23 sends the sensing results of the steering angle to the processing unit 10.

The power steering control unit 30 sends, to the steering actuator 40 that controls the steering angle of the vehicle, a command indicating the torque to be generated by the steering actuator 40. Moreover, the power steering control unit 30 acquires the steering torque from a not-shown torque sensor. The torque sensor is a well-known one provided in a well-known electric power steering system. In addition, instead of the steering actuator 40, a brake mechanism may be employed which changes the traveling direction of the vehicle by applying a brake only to a right wheel or a left wheel of the vehicle. In other words, it is possible to employ, instead of the steering actuator 40, an actuator that has a function of changing the traveling direction of the vehicle.

Next, each of the units 11-14 as which the processing unit 10 functions will be described. The driver torque detection unit 11 acquires the steering torque from the power steering control unit 30. Then, based on the steering torque, the driver torque detection unit 11 determines the driver torque which is the torque inputted by the driver to the steering wheel of the vehicle. For example, when no torque is generated by the steering actuator 40, it is possible to directly determine the steering torque to be the driver torque. In contrast, when torque is generated by the steering actuator 40, it is possible to determine the result of subtracting the torque generated by the steering actuator 40 from the steering torque to be the driver torque. Moreover, as appropriate, it is also possible to determine the driver torque through a correction taking into account the road surface input torque or the like. In addition, the torque generated by the steering actuator 40 may be either an actual measured value or a value calculated using the torque command outputted by the power steering control unit 30.

The control torque outputting unit 12 executes, based on the aforementioned departure angle and lateral position, a steering control necessity determination process for determining whether it is necessary to perform the steering control for keeping the position of the own vehicle in the current traveling lane. In addition, the steering control for lane keeping includes not only a steering control for suppressing the own vehicle from departing from the lane, but also a steering control for returning the own vehicle after a departure to the lane before the departure. In the steering control necessity determination process, the road radius and the road width may be used in addition to the departure angle and the lateral position. Since the steering control necessity determination process is a well-known process, more explanation thereof is omitted hereinafter.

When it is determined, in the steering control necessity determination process, that it is necessary to perform the steering control, the control torque outputting unit 12 further determines the steering torque to be generated by the steering actuator 40 and performs a torque requiring process for outputting steering required torque to the power steering control unit 30. The steering required torque represents the magnitude of the steering torque to be generated by the steering actuator 40. The steering required torque corresponds to the control torque in the claims. In addition, the steering required torque also includes information indicating the steering direction. For example, the steering direction is indicated by a positive or negative sign.

The steering control necessity determination process is executed under a start condition that a control main switch (not shown) is turned on. The start condition may include, in addition to the fact that the control main switch is turned on, conditions such as the vehicle speed and the like.

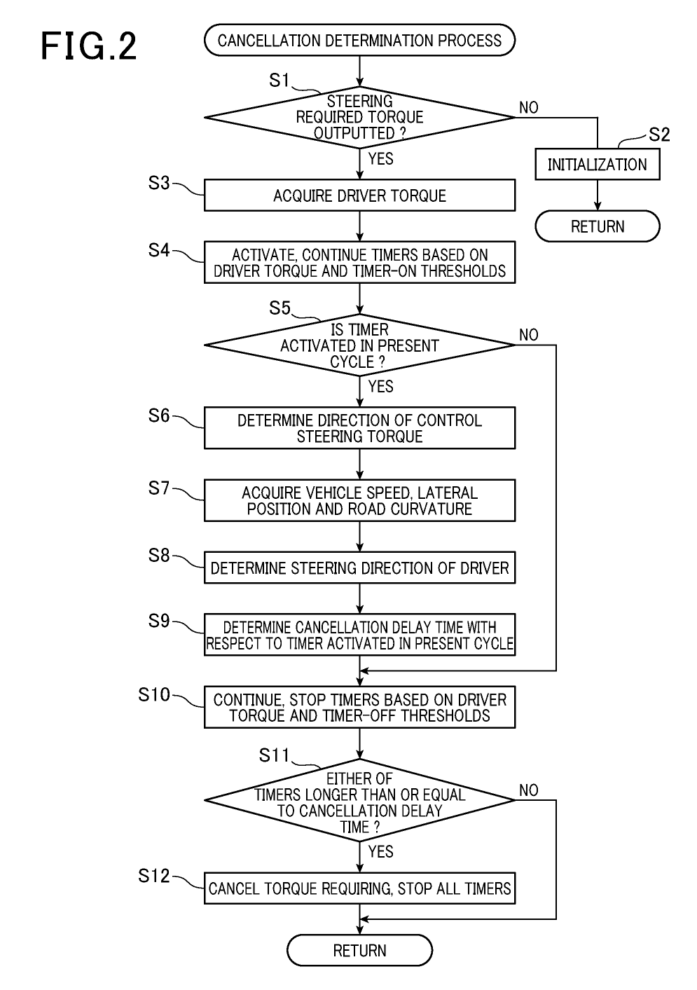

Further, the control torque outputting unit 12 executes part of a cancellation determination process shown in FIG. 2 in addition to the steering control necessity determination process and the torque requiring process. The cancellation determination process is executed either following the steering control necessity determination process and the torque requiring process or in parallel with the steering control necessity determination process and the torque requiring process by a time-sharing process. The cancellation determination process is a process of determining, based on the driver torque, whether or not to cancel the output of the steering required torque.

In FIG. 2, first, at step S1, it is determined whether or not the steering required torque is outputted. If the result of this determination is NO, the process proceeds to step S2. At step S2, an initialization process is executed. Specifically, in the initialization process, timers 1 and 2 are cleared. After executing step S2, the process returns to the beginning of FIG. 2, i.e., to step S1.

If the result of step S1 is YES, the process proceeds to step S3. At step S3, the driver torque is acquired from the driver torque detection unit 11. At step S4, the driver torque acquired at step S3 is compared with each of preset timer-ON thresholds 1 and 2. Then, if the driver torque is higher than the timer-ON threshold, the timer corresponding to the compared timer-ON threshold is placed in a measurement state. That is, if the timer has not been activated, then it is activated; if the timer has already been activated, then the activation is continued. In addition, the value of the timer corresponds to the duration in the claims.

In addition, the timer 1 corresponds to the timer-ON threshold 1, and the timer 2 corresponds to the timer-ON threshold 2. Moreover, when the driver torque exceeds the timer-ON threshold in the state of the timer having not been activated, it is determined that the driver torque is inputted. Since there are provided two timer-ON thresholds, there are accordingly made two types of determinations that the driver torque is inputted.

At step S5, it is determined whether or not there is a timer activated in the present cycle. If the result of this determination is NO, the process directly proceeds to step S10.

If the result of the determination at step S5 is YES, it means that no cancellation delay time has been set. Therefore, steps S6-S9 are executed for setting a cancellation delay time. At step S6, the generation direction of the control torque is determined. This determination is made based on the steering required torque.

At step S7, the current vehicle speed, lateral position (corresponding to the position in the lane width direction in the claims) and road curvature are acquired. The vehicle speed is acquired from the vehicle speed sensor 21. The lateral position is represented by the distances from the own vehicle to the lane boundary lines, and obtained through a calculation based on the positions of the lane boundary lines in the images detected by the camera 20. The road curvature is acquired regarding the curvature of the lane boundary lines as the road curvature. The curvature of the lane boundary lines are acquired through a calculation based on the curvature of the lane boundary lines included in the images captured by the camera 20.

At step S8, the steering direction of the driver is determined. This is determined based on change in the steering angle successively acquired by the steering angle sensor 23.

At step S9, based on the driver torque acquired at step S3 and the information determined or acquired at steps S6-S8, the cancellation delay time is determined with respect to the timer activated at step S4 in the present cycle.

The cancellation delay time determined here has the following tendency. First, when the generation direction of the control torque determined at step S6 and the steering direction of the driver determined at step S8 are opposite to each other, the cancellation delay time is set to be shorter than when these directions are the same. Moreover, in this first embodiment, the cancellation delay time is reduced in stages according to the magnitude of the driver torque. In addition, for the sake of simplifying the explanation, the number of the stages is set to 2.

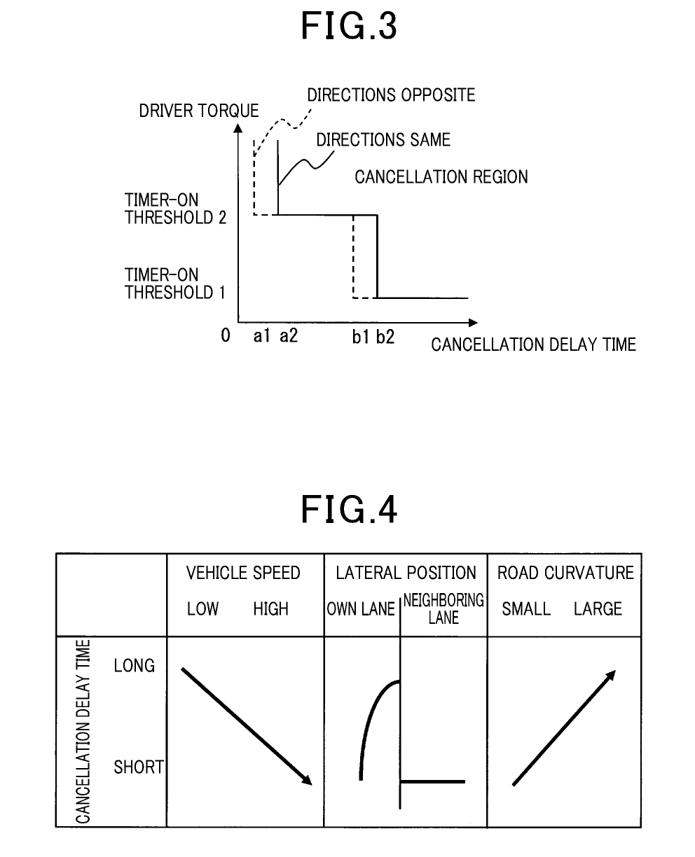

FIG. 3 illustrates an example of a graph for setting the cancellation delay time according to whether the direction of the control torque and the direction of the driver torque are opposite to each other or the same and to the magnitude of the driver torque.

In FIG. 3, the dashed line is a line for determining the cancellation delay time in the case of the control torque and the driver torque being in opposite directions; the continuous line is a line for determining the cancellation delay time in the case of the control torque and the driver torque being in the same direction.

Using the graph of FIG. 3, for example, when the direction of the control torque and the direction of the driver torque are opposite to each other and the driver torque is higher than the timer-ON threshold 2, the cancellation delay time is set to a1. With the same magnitude of the driver torque, the cancellation delay time is set to a2 when the direction of the control torque and the direction of the driver torque are the same.

Moreover, with the driver torque being between the timer-ON thresholds 1 and 2, the cancellation delay time is set to b1 when the direction of the control torque and the direction of the driver torque are opposite to each other and to b2 when the direction of the control torque and the direction of the driver torque are the same. In addition, b1 and b2 are of the order of about 1 second.

For the following reason, the cancellation delay time is set to be shorter when the direction of the control torque and the direction of the driver torque are opposite to each other than when these directions are the same. That is, this is because it is highly probable that the control torque in the direction opposite to the direction in which the driver is operating the steering wheel will result in a control against the driver's intension.

For the following reason, the cancellation delay time is set to be short when the driver torque is high. That is, in situations where it is required to quickly perform steering, such as a situation where an obstacle suddenly appears right in front of the driver's eyes, the control should be quickly canceled so as to quickly reflect the driver's intension. Moreover, in these situations, the driver torque would be high.

FIG. 3 illustrates the relationship of the cancellation delay time with the directions of the control torque and the driver torque being opposite to each other or the same and with the magnitude of the driver toque. However, in the first embodiment, the cancellation delay time determined by the relationship shown in FIG. 3 is used as a base value; a final cancellation delay time is determined by correcting the base value based on the vehicle speed, lateral position and road curvature acquired at step S7. In addition, instead of performing the correction at each time, it is also possible to prepare in advance a map corrected with these vehicle speed, lateral position and road curvature.

FIG. 4 illustrates the relationship of the cancellation delay time with the vehicle speed, the lateral position and the road curvature. When the vehicle speed becomes relatively high, the cancellation delay time is reduced. The reason is as follows. When the vehicle speed is high, the traveling distance per unit time is long and thus it is required for the steering to be quickly performed. Therefore, when the steering wheel is operated by the driver, it is required for the steering reflecting the driver's intension to be quickly performed. In addition, though the cancellation delay time is continuously reduced according to the vehicle speed in FIG. 4, the cancellation delay time may also be changed in stages.

As to the lateral position, as long as the position of the own vehicle is in the own lane, the closer the own vehicle to a neighboring lane, the longer the cancellation delay time is set. This is because the situation where the own vehicle approaches a lane boundary line is basically a situation where the control torque should be generated to suppress a lane departure. In addition, the state where the position of the own vehicle is in the own lane may be defined as until one of the left and right edges of the own vehicle reaches a lane boundary line, until the other edge also reaches the lane boundary line, or a predetermined position between the two limits.

When the lateral position is in a neighboring lane, the cancellation delay time is set to be shorter than when the lateral position is in the own lane and close to the neighboring lane. Moreover, in the neighboring lane, the cancellation delay time is set to a constant value regardless of the specific position. This is because in the state where the lateral position has been changed to the neighboring lane, it is highly probable that the lane change has been made based on the driver's decision.

When the road curvature is large, the cancellation delay time is set to be longer than when the road curvature is small. The reason is as follows. When the road curvature is large, even in the state where the lane is kept by the steering of the driver, in other words, even in the state where it is unnecessary to generate the control torque, it is easy for a certain level of the driver torque to be inputted. Therefore, if the cancellation delay time was set to be short, the output of the steering required torque might be frequently canceled in situations where it should not be canceled. In addition, though the cancellation delay time is continuously reduced according to the road curvature in FIG. 4, the cancellation delay time may also be changed in stages.

As described previously, the final cancellation delay time is set by correcting the cancellation delay time, which is determined by the directions of the control torque and the driver torque being opposite to each other or the same and the magnitude of the driver toque, based on the relationship of the cancellation delay time with the vehicle speed, the lateral position and the road curvature as shown in FIG. 4.

At step S10, the driver torque acquired at step S3 is compared with each of timer-OFF thresholds 1 and 2 preset respectively for the timers 1 and 2. These timer-OFF thresholds 1 and 2 are set to be respectively lower than the corresponding timer-ON thresholds 1 and 2. By way of example, the timer-OFF thresholds 1 and 2 are set to be lower than the timer-ON thresholds 1 and 2 by 1 Nm. If the driver torque is lower than the compared timer-OFF threshold, the timer corresponding to the timer-OFF threshold is stopped. In contrast, if the driver torque is not lower than the compared timer-OFF threshold, the timer corresponding to the timer-OFF threshold is continued.

At step S11, it is determined whether or not either of the timers has become longer than or equal to the cancellation delay time set for the timer. If the result of this determination is NO, the process returns to step S1. In contrast, if the result of this determination is YES, the process proceeds to step S12.

At step S12, the steering required torque is cancelled. That is, the output of the steering required torque is stopped. Moreover, this makes the counting of the timers no longer necessary; therefore, all of the timers are stopped. Thereafter, the process returns to step S1.

In the above-described cancellation determination process, step S3 is executed by the driver torque detection unit 11; steps S6-S9 are executed by the cancellation delay time setting unit 13; steps S4 and S10 are executed by the timer measurement unit 14; the remaining steps are executed by the control torque outputting unit 12.

### Advantageous Effects of First Embodiment

According to the above-described first embodiment, in the state where the steering required torque is outputted (S1: YES), the steering required torque is canceled, in other words, the output of the steering required torque is stopped (S12) based on the fact that the state of the driver torque being inputted has continued (S11: YES). Moreover, the cancellation delay time, which represents the length of time from when the driver torque is inputted until the steering required torque is canceled, is set to be shorter when the driver torque is higher than or equal to the timer-ON threshold 2 than when the driver torque is between the timer-ON threshold 1 and the timer-ON threshold 2. Consequently, in the case where the steering wheel is quickly turned by the driver and thus high torque is inputted to the steering wheel, the control torque will be canceled in a short time and thus the steering will be performed in quick response to the steering wheel operation of the driver. As a result, an uncomfortable feeling caused to the driver will be suppressed.

Moreover, in the case where the steering wheel operation of the driver is performed relatively slowly, the driver torque will be low and thus the cancellation delay time will be long in comparison with the case where the driver torque is high. Consequently, with the slow operation of the steering wheel which is performed, for example, to avoid a large-sized vehicle in a neighboring lane, it will be difficult for the steering required torque to be canceled. Therefore, in situations where the control torque should be generated, the chances that it is impossible to generate the control torque will be reduced.

### Second Embodiment

Next, the second embodiment will be described. In addition, from the second embodiment on, unless specified otherwise, elements having reference signs identical to those used hitherto are identical to the elements having the identical reference signs in the previous embodiment. Moreover, in the case of describing only part of a configuration, the previous embodiment can be applied to the remaining part of the configuration.

In the first embodiment, the steering required torque is canceled based on the fact that the time for which the driver torque has become higher than or equal to the threshold exceeds the cancellation delay time. That is, the cancellation is determined based on time. In comparison, in the second embodiment, the cancellation is determined based on a torque integral value.

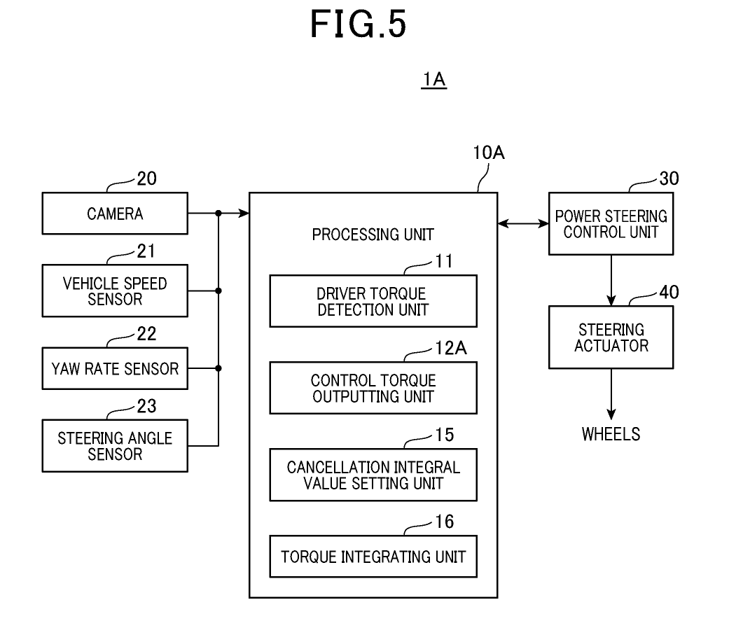

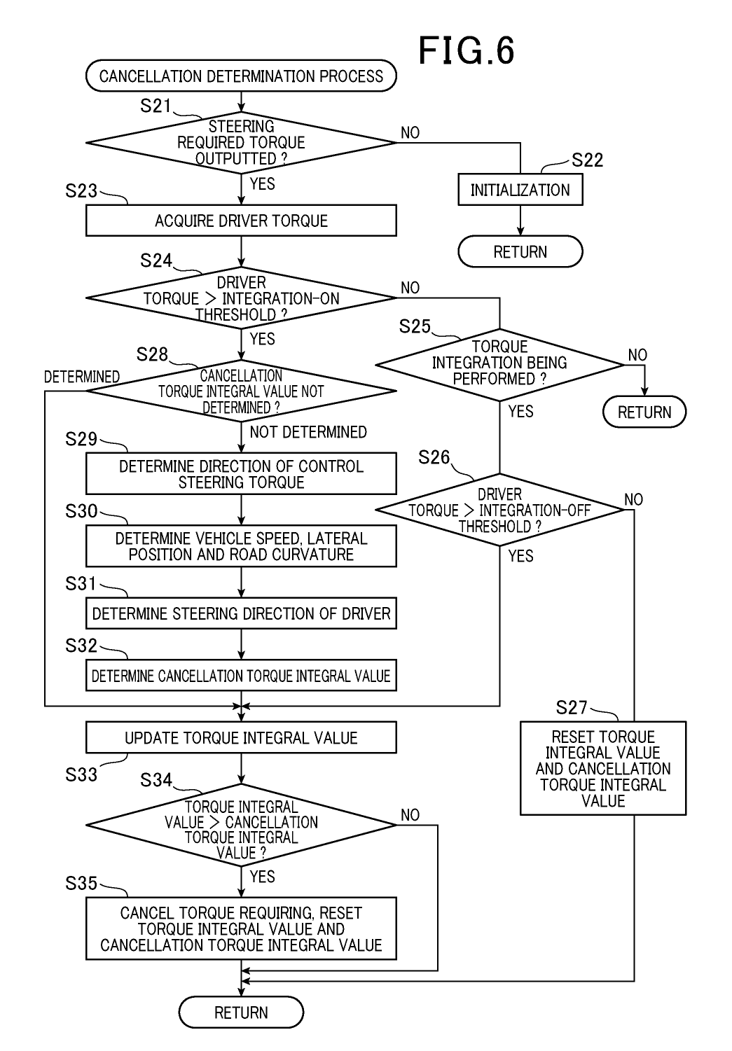

FIG. 5 illustrates the overall configuration of a lane keeping assist system 1A according to the second embodiment. As shown in the figure, a processing unit 10A in the second embodiment includes a cancellation integral value setting unit 15 and a torque integrating unit 16. These units are provided instead of the cancellation delay time setting unit 13 and the timer measurement unit 14 in the first embodiment. Moreover, the tasks of a control torque outputting unit 12A in a process shown in FIG. 6 differ from those of the control torque outputting unit 12 in the first embodiment.

With reference to FIG. 6, the process of the processing unit 10A in the second embodiment will be described. Steps S21-S23 are identical to steps S1-S3 in FIG. 2. That is, if the steering required torque is outputted (S21: YES), the driver torque is acquired (S23); if the steering required torque is not outputted (S21: NO), the initialization process is executed (S22).

After having acquired the driver torque, the process proceeds to step S24. At step S24, it is determined whether or not the driver torque acquired at step S23 is higher than a preset integration-ON threshold. The integration-ON threshold is set to, for example, the same value as the lower timer-ON threshold in the first embodiment.

If the result of the determination at step S24 is NO, the process proceeds to step S25. In contrast, if the result of the determination at step S24 is YES, the process proceeds to step S28.

At step S25, it is determined whether or not a torque integration is being performed. If the result of the determination at step S25 is YES, the process proceeds to step S26. In contrast, if the result of the determination at step S25 is NO, the process returns to step S21.

At step S26, it is determined whether or not the driver torque acquired at step S23 is higher than a preset integration-OFF threshold. The integration-OFF threshold is set to, for example, the same value as the lower timer-OFF threshold in the first embodiment.

If the torque integration is being performed (S25: YES), but the driver torque has become lower than the integration-OFF threshold (S26: NO), the process proceeds to step S27, at which both a torque integral value and a cancellation torque integral value are reset. Thereafter, the process returns to step S21.

On the other hand, if the result of the determination at step S26 is YES, the process proceeds to step S33. Step S33 will be described later.

If the driver torque is higher than the integration-ON threshold in the determination at step S24, in other words, if the result of the determination at step S24 is YES, the process proceeds to step S28. At step S28, it is determined whether the cancellation torque integral value has not been determined yet. If it has not been determined, the process proceeds to step S29. In contrast, if it has been determined, the process proceeds to step S33.

At step S29, the direction of the control torque is determined. At step S30, the vehicle speed, the lateral position of the vehicle and the road curvature are determined. At step S31, the steering direction of the driver is determined. These steps S29-S31 are identical to the steps S6-S8 in FIG. 2.

At step S32, the cancellation torque integral value is determined based on the driver torque acquired at step S23 and the information determined or acquired at steps S29-S31.

The cancellation torque integral value is a threshold of the torque integral value for determining cancellation of the steering required torque. In the first embodiment, the base value of the cancellation delay time is determined based on the direction of the control torque and the steering direction of the driver being opposite to each other or the same and the magnitude of the driver toque. In comparison, in the second embodiment, a base value of the cancellation torque integral value is determined based only on the direction of the control torque and the steering direction of the driver being opposite to each other or the same, without considering the magnitude of the driver toque.

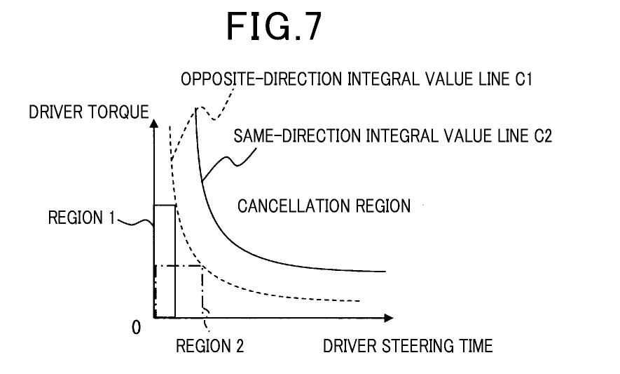

In the second embodiment, the magnitude of the driver torque is not considered in determining the cancellation torque integral value. The reason is explained here with reference to FIG. 7. The torque integral value is a value obtained by adding the torque from time to time. Therefore, for example, a region 1 and a region 2 in FIG. 7 have the same torque integral value. Accordingly, the torque integral value is a value also reflecting the magnitude of the torque that varies from time to time. In the first embodiment, if the driver torque is higher than the integration-ON threshold, the timer, which is compared with the threshold, namely the cancellation delay time, is advanced and the magnitude of the driver torque is not considered; therefore, it is necessary to vary the cancellation delay time. In comparison, in the second embodiment, since the magnitude of the driver torque is reflected in the torque integral value, it is unnecessary to vary the cancellation torque integral value, which is the threshold to be compared with the torque integral value, according to the driver torque.

However, as in the first embodiment, the magnitude of the cancellation torque integral value varies according to whether or not the directions of the control torque and the driver torque are the same. In FIG. 7, each of an opposite-direction integral value line C1 and a same-direction integral value line C2 is a curve such that the area of a rectangle taking an arbitrary point on the line as a vertex thereof is equal to a constant value. As described previously, the area of the rectangle represents the torque integral value. The opposite-direction integral value line C1 is a curve representing the cancellation torque integral value when the directions of the control torque and the driver torque are opposite to each other. The same-direction integral value line C2 is a curve representing the cancellation torque integral value when the directions of the control torque and the driver torque are the same. As seen from comparison between the opposite-direction integral value line C1 and the same-direction integral value line C2, the cancellation torque integral value is greater when the directions of the control torque and the driver torque are the same than when the directions of the control torque and the driver torque are opposite to each other.

The tendency in correcting the base value of the cancellation torque integral value based on the vehicle speed, the lateral position and the road curvature is the same as in the first embodiment. As a matter of course, since the cancellation delay time and the cancellation torque integral value are different physical quantities, the degree of the correction is different from that in the first embodiment. Moreover, as in the first embodiment, it is also possible to prepare in advance a map taking into account the vehicle speed, the lateral position and the road curvature. After having determined the final cancellation torque integral value, the process proceeds to step S33.

At step S33, the torque integral value is updated by adding the driver torque acquired at step S23 of the present cycle to the torque integral value of the previous cycle. At step S34, it is determined whether or not the torque integral value after the update at step S33 is greater than the cancellation torque integral value. If the result of this determination is NO, the process returns to step S21. On the other hand, if the result of this determination is YES, the process proceeds to step S35. In addition, in the case of the result of the determination at step S34 being YES, the state of the driver torque being higher than or equal to the integration-ON threshold has continued until the torque integral value becomes higher than the cancellation torque integral value.

At step S35, the steering required torque is canceled. Moreover, since it becomes unnecessary to integrate the driver torque, the torque integral value is reset. In addition, the cancellation torque integral value is also reset. Thereafter, the process returns to step S21.

In the above-described cancellation determination process, step S23 is executed by the driver torque detection unit 11; steps S29-S32 are executed by the cancellation integral value setting unit 15; step S33 is executed by the torque integrating unit 16; the remaining steps are executed by the control torque outputting unit 12A.

### Advantageous Effects of Second Embodiment

According to the above-described second embodiment, in the state where the steering required torque is outputted (S21: YES), the steering required torque is canceled (S35) based on the fact that the state of the driver torque being inputted has continued (S34: YES). Moreover, since the steering required torque is canceled based on the fact that the torque integral value has become greater than the cancellation torque integral value, the higher the driver torque, the shorter the time from when the driver torque is inputted until the steering required torque is canceled. Consequently, as in the first embodiment, in the case where the steering wheel is quickly turned by the driver and thus high torque is inputted to the steering wheel, the control torque will be canceled in a short time. As a result, an uncomfortable feeling caused to the driver will be suppressed.

Moreover, in the case where the steering wheel operation of the driver is performed relatively slowly, the driver torque will be low and thus the time from when the driver torque is inputted until the steering required torque is canceled will be long in comparison with the case where the driver torque is high. Consequently, in situations where the control torque should be generated, the chances that it is impossible to generate the control torque will be reduced.

The embodiments of the present invention have been described above. However, the present invention is not limited to the above embodiments and can be carried out through various modifications without departing from the spirit of the present invention.

For example, in the first and second embodiments, the base values of the cancellation delay time and the cancellation torque integral value are corrected based on the vehicle speed, the lateral position and the road curvature. However, these corrections based on the vehicle speed, the lateral position and the road curvature may not be performed (First Modification). Moreover, the base values of the cancellation delay time and the cancellation torque integral value may be corrected based on only one or two of the vehicle speed, the lateral position and the road curvature (Second Modifications).

Moreover, the base values of the cancellation delay time and the cancellation torque integral value may be set without considering whether the direction of the control torque and the direction of the driver torque are opposite to each other or the same (Third Modification). Regarding the cancellation torque integral value, in the case of not considering whether the direction of the control torque and the direction of the driver torque are opposite to each other or the same, it is possible to set the cancellation torque integral value to a fixed value.

Moreover, in the first embodiment, the two types of ON thresholds are used. However, it is also possible to use three or more types of ON thresholds (Fourth Modification).

In the first embodiment, the higher the driver torque, the shorter the cancellation delay time is set to be. Consequently, the higher the driver torque, the shorter the time from when the driver torque is inputted until the output of the control torque is stopped will be. However, in contrast to the tendency in the first embodiment, it is also possible to design the system so that the higher the driver torque, the longer the time from when the driver torque is inputted until the output of the control torque is stopped will be. In this case, the cancellation delay time may be set based on, for example, a relationship obtained by inverting the vertical axis in FIG. 3 (Fifth Modification).

### DESCRIPTION OF REFERENCE SIGNS

1, 1A: lane keeping assist system; 10, 10A: processing unit (lane keeping assist apparatus); 11: driver torque detection unit; 12, 12A: control torque outputting unit; 13: cancellation delay time setting unit; 14: timer measurement unit; 15: cancellation integral value setting unit; 16: torque integrating unit; 20: camera; 21: vehicle speed sensor; 22: yaw rate sensor; 23: steering angle sensor; 30: power steering control unit (steering torque control unit); 40: steering actuator.

1. A lane keeping assist apparatus (10, 10A) installed on a vehicle, the lane keeping assist apparatus comprising:
a control torque outputting unit (12, 12A) that outputs control torque for keeping the vehicle in a traveling lane; and
a driver torque detection unit (11) that detects driver torque, the driver torque being torque inputted by a driver of the vehicle to a steering wheel of the vehicle,
characterized in that
in a state of outputting the control torque, the control torque outputting unit stops the output of the control torque based on the detection of the driver torque, and
the control torque outputting unit varies, according to the driver torque detected by the driver torque detection unit, a time from when the driver torque is inputted until the output of the control torque is stopped.

2. The lane keeping assist apparatus as set forth in claim 1, further characterized in that the higher the driver torque detected by the driver torque detection unit, the time from when the driver torque is inputted until the output of the control torque is stopped is reduced in stages or continuously.

3. The lane keeping assist apparatus as set forth in claim 1, further characterized in that the higher the driver torque detected by the driver torque detection unit, the time from when the driver torque is inputted until the output of the control torque is stopped is increased in stages or continuously.

4. The lane keeping assist apparatus as set forth in any one of claims 1-3, further comprising:
a cancellation delay time setting unit (13) that sets, in the state where the control torque is outputted, a cancellation delay time that varies according to the magnitude of the driver torque; and
a timer measurement unit (14) that measures a duration in which the driver torque is determined to be continuously inputted,
characterized in that
the control torque outputting unit stops the output of the control torque based on the fact that the duration measured by the timer measurement unit exceeds the cancellation delay time set by the cancellation delay time setting unit.

5. The lane keeping assist apparatus as set forth in claim 4, further characterized in that
the timer measurement unit has a plurality of timer-ON thresholds, which are thresholds of the driver torque for starting the measurement of the duration, and performs the measurement of the duration corresponding to each of the timer-ON thresholds,
the cancellation delay time setting unit compares each of the timer-ON thresholds with the driver torque and sets the cancellation delay time for each of those timer-ON thresholds than which the driver torque is higher, and
the control torque outputting unit stops the output of the control torque based on the fact that any of the durations measured by the timer measurement unit respectively for the timer-ON thresholds exceeds the cancellation delay time corresponding to the duration.

6. The lane keeping assist apparatus as set forth in claim 5, further characterized in that
the timer measurement unit has timer-OFF thresholds respectively corresponding to the timer-ON thresholds, the timer-OFF thresholds being thresholds of the driver torque for stopping the measurement of the duration,
each of the timer-OFF thresholds is set to a lower value than the corresponding timer-ON threshold, and
during the measurement of the duration, if the driver torque is lower than the timer-ON threshold but higher than or equal to the timer-OFF threshold, the measurement of the duration is continued.

7. The lane keeping assist apparatus as set forth in any one of claims 4-6, further characterized in that the cancellation delay time setting unit sets the cancellation delay time to different times according to whether a generation direction of the control torque and a direction in which the steering wheel is turned by the driver torque are the same or opposite to each other.

8. The lane keeping assist apparatus as set forth in any one of claims 4-7, further characterized in that the cancellation delay time setting unit sets a final cancellation delay time by correcting, based on at least one of a vehicle speed, a position of the vehicle in a lane width direction and a road curvature, the cancellation delay time determined based on the driver torque.

9. The lane keeping assist apparatus as set forth in claim 1 or 2, further comprising a torque integrating unit (16) that successively calculates a torque integral value by successively integrating the driver torque from when the driver torque is determined to be inputted,
characterized in that
the control torque outputting unit stops the output of the control torque based on the fact that the torque integral value calculated by the torque integrating unit exceeds a preset cancellation torque integral value.

10. The lane keeping assist apparatus as set forth in claim 9, further characterized by comprising a cancellation integral value setting unit (15) that sets the cancellation torque integral value to different values according to whether a generation direction of the control torque and a direction in which the steering wheel is turned by the driver torque are the same or opposite to each other.

11. The lane keeping assist apparatus as set forth in claim 10, further characterized in that the cancellation integral value setting unit sets a final cancellation torque integral value by correcting, based on at least one of a vehicle speed, a position of the vehicle in a lane width direction and a road curvature, the cancellation torque integral value determined based on whether the generation direction of the control torque and the direction in which the steering wheel is turned by the driver torque are the same or opposite to each other.

12. The lane keeping assist apparatus as set forth in any one of claims 9-11, further characterized in that
the torque integrating unit has an integration-ON threshold and an integration-OFF threshold, the integration-ON threshold being a threshold of the driver torque for starting the calculation of the torque integral value, the integration-OFF threshold being a threshold of the driver torque for stopping the calculation of the torque integral value, and
the integration-OFF threshold is set to be lower than the integration-ON threshold.
